(19) United States
(12) Patent Application Publication
(10) Pub. No.: US 2026/0027789 A1
(43) Pub. Date: Jan. 29, 2026

(54) METHOD FOR MANUFACTURING CONTACT BODY THAT IS USED FOR VIBRATION-TYPE ACTUATOR, AND VIBRATION-TYPE ACTUATOR

(71) Applicant: CANON KABUSHIKI KAISHA, Tokyo (JP)

(72) Inventor: YASUYUKI ARAKI, Tokyo (JP)

(21) Appl. No.: 19/349,855

(22) Filed: Oct. 3, 2025

Related U.S. Application Data
(63) Continuation of application No. PCT/JP2024/014987, filed on Apr. 15, 2024.

(30) Foreign Application Priority Data
Apr. 25, 2023 (JP) 2023-071681

(51) Int. Cl. B29C 70/68; B06B 1/06; B29C 70/00; B29K 63/00; B29K 705/12; B29L 31/34

(52) U.S. Cl. CPC B29C 70/682; B06B 1/0648; B29C 70/003; B06B 2201/55; B29K 2063/00; B29K 2705/12; B29K 2995/0063; B29L 2031/3406

(57) ABSTRACT

A method for manufacturing a contact body that is used for a vibration-type actuator, the method includes applying resin having viscosity of 8,000 millipascal-second (mPa·s) or higher to a part of surfaces of a sintered body having pores, covering pores in a surface of the sintered body that is different from the part of the surfaces, and impregnating the sintered body with the resin applied to the sintered body by placing the sintered body under a first air pressure lower than an atmospheric pressure.

### CROSS-REFERENCE TO RELATED APPLICATIONS

This application is a Continuation of International Patent Application No. PCT/JP2024/014987, filed Apr. 15, 2024, which claims the benefit of Japanese Patent Application No. 2023-071681, filed Apr. 25, 2023, both of which are hereby incorporated by reference herein in their entirety.

### BACKGROUND

### Field of the Technology

The present disclosure relates to a method for manufacturing a contact body that is used for a vibration-type actuator, and a vibration-type actuator.

### Description of the Related Art

A vibration-type actuator is known in which a vibration body and a contact body are brought into contact with each other, a predetermined vibration is excited (generated) in the vibration body, and a frictional driving force is applied from the vibration body to the contact body, whereby the contact body is caused to move relative to the vibration body (hereinafter also referred to as ‘relative movement’). In the vibration-type actuators, an electromechanical energy conversion element, such as a piezoelectric element, is joined to the vibration body, and the vibration is generated in the vibration body by applying an alternating-current voltage to the electromechanical energy conversion element.

Such a vibration-type actuator is characterized by a high holding force, as it uses a frictional force generated due to the contact. Therefore, even when an external force is applied in a non-energized state, the positional relationship between the vibration body and the contact body can be maintained (the vibration body and the contact body can be remained stationary at their positions).

Japanese Patent Laid-Open No. 2022-30103 describes a frictional member in which a stainless-steel sintered body is impregnated with resin mixed with hard particles as a contact body for use in such a vibration-type actuator. The resin with which this frictional member is impregnated contributes to improvement of wear resistance and maintenance of a high friction coefficient as a sliding member. In addition, the hard particles exbibit a spike effect, and therefore the frictional member can maintain the high friction coefficient even after being placed in a high-temperature and high-humidity state, which may ensure reliable operation.

In a case where the contact body contains the resin in pores of the stainless-steel sintered body, the holding force exhibited by the vibration-type actuator using the contact body is expected to increase as the amount of contained resin increases in the pores in a contact surface that is in contact with the vibration body. These circumstances have led to a growing demand for development of a contact body containing a greater amount of resin in the pores in the contact surface. In a case where a large amount of resin is present even at positions deeper than the contact surface, the vibration-type actuator is expected to maintain the holding force even when the contact surface is worn.

### SUMMARY

The present disclosure is directed to providing a method for manufacturing a contact body that is used for a vibration-type actuator, and is a method for manufacturing a contact body containing greater amount of resin in pores in a contact surface and also containing a greater amount of resin even at a position deeper than the contact surface.

The present disclosure is directed to providing a vibration-type actuator including a contact body containing a greater amount of resin in pores in a contact surface and also containing a greater amount of resin even at a position deeper than the contact surface.

A method for manufacturing a contact body that is used for a vibration-type actuator, the method includes applying resin having viscosity of 8,000 millipascal-second (mPa·s) or higher to a part of surfaces of a sintered body having pores, covering pores in a surface of the sintered body that is different from the part of the surfaces, and impregnating the sintered body with the resin applied to the sintered body by placing the sintered body the under a first air pressure lower than an atmospheric pressure.

A vibration-type actuator includes a vibrator including an electromechanical energy conversion element and an elastic body, and a contact body configured to be in contact with a surface of the elastic body on a contact surface of the contact body, wherein the vibrator and the contact body move relative to each other due to a vibration of the vibrator, wherein the contact body includes a sintered body having pores, and a resin part containing resin in the pores, and wherein the following inequality is satisfied:

$$( {A}_{0} - {A}_{50} ) / {A}_{0} \leq 0.25$$

where A₀ is a proportion of an area occupied by the resin part in the contact surface A₅₀ is a proportion of an area occupied by the resin part in a surface when the contact surface is polished by 50 micrometers (μm) in a depth direction perpendicular to the contact surface, and A₀ is 8% or higher.

Features of the present disclosure will become apparent from the following description of embodiments with reference to the attached drawings.

### BRIEF DESCRIPTION OF THE DRAWINGS

FIG. 1A is a schematic view illustrating a contact surface of a contact body according to first to third embodiments.

FIG. 1B is a diagram illustrating a resin content of the contact body according to the first to third embodiments.

FIG. 2 is a diagram illustrating a vibration-type actuator according to the first to third embodiments.

FIG. 3A is a diagram illustrating a vibration body of the vibration-type actuator according to the first to third embodiments.

FIG. 3B is a diagram illustrating the vibration body of the vibration-type actuator according to the first to third embodiments.

FIG. 4A is a perspective view illustrating a method for manufacturing the contact body according to the first embodiment.

FIG. 4B is a cross-sectional view illustrating the method for manufacturing the contact body according to the first embodiment.

FIG. 4C is a cross-sectional view illustrating the method for manufacturing the contact body according to the first embodiment.

FIG. 4D is a cross-sectional view illustrating the method for manufacturing the contact body according to the first embodiment.

FIG. 5A is a perspective view illustrating a method for manufacturing the contact body according to the second embodiment.

FIG. 5B is a cross-sectional view illustrating the method for manufacturing the contact body according to the second embodiment.

FIG. 5C is a cross-sectional view illustrating the method for manufacturing the contact body according to the second embodiment.

FIG. 6A is a perspective view illustrating a method for manufacturing the contact body according to the third embodiment.

FIG. 6B is a cross-sectional view illustrating the method for manufacturing the contact body according to the third embodiment.

FIG. 6C is a cross-sectional view illustrating the method for manufacturing the contact body according to the third embodiment.

FIG. 7 is a diagram illustrating a vibration-type actuator including a ring-shaped contact body.

FIG. 8A is a diagram illustrating a configuration of an imaging apparatus such as a camera including the vibration-type actuator according to the present disclosure.

FIG. 8B is a diagram illustrating the configuration of the imaging apparatus such as the camera including the vibration-type actuator according to the present disclosure.

FIG. 9 is a perspective view schematically illustrating the structure of a robot including the vibration-type actuator according to the present disclosure.

### DESCRIPTION OF THE EMBODIMENTS

As a contact body that is used for vibration-type actuators, there is known sintered body containing resin in pores, which are acquired by performing impregnation processing on a sintered body including pores. Such a contact body is required to contain a great amount of resin in pores in a surface on which the contact body is in contact with a vibration body (hereinafter referred to as a contact surface) to exhibit a high holding force with the vibration body included in the vibration-type actuator.

As a result of earnest research and study, the present inventors have discovered that a greater amount of resin can be contained in the pores by performing impregnation processing under a vacuum environment. More specifically, the present inventors have discovered that the amount of contained resin in the pores is improved by processing of placing the sintered body under a vacuum environment after applying flowable resin to the surface of the sintered body or processing of applying resin to the surface of the sintered body placed under a vacuum environment, in comparison to impregnation processing under a normal pressure.

Further, the present inventors have discovered that the efficiency of the impregnation processing under the vacuum environment can be improved by covering surfaces different from a surface to which the resin is applied (hereinafter referred to as an application surface), among the surfaces of the sintered body, with an adhesion-resistant tool, a container, or the like, in advance. The mechanism behind this is presumed to be as follows.

First, as the impregnation processing, the sintered body with its application surface covered with the resin and the surfaces, other than the application surface, covered with the adhesion-resistant tool or the container is held under the vacuum environment. The resin may be applied to the surface of the sintered body in a state of being held under the vacuum environment. In this processing, gas, such as air present inside the pores of the sintered body, is extracted out of the sintered body as the air pressure is lower there, due to a difference between the air pressure inside the pores and the air pressure outside the sintered body. After that, the sintered body is maintained under a normal pressure or an air pressure close thereto. In this processing, the air outside the sintered body is pulled into the pores where the air pressure is lower, which causes the resin applied to the surface of the sintered body to be pushed into the pores.

In this manner, by covering the surfaces different from the application surface with the container or the adhesion-resistant tool in advance and performing the impregnation processing under the vacuum environment, the contact body containing a large amount of resin in the contact surface can be acquired. With this configuration, even in a case where the contact surface is worn the contact body in which the amount of contained resin in the contact surface is less likely to decrease.

In the following description, each embodiment of the present disclosure will be described in detail with reference to the drawings.

### First Embodiment

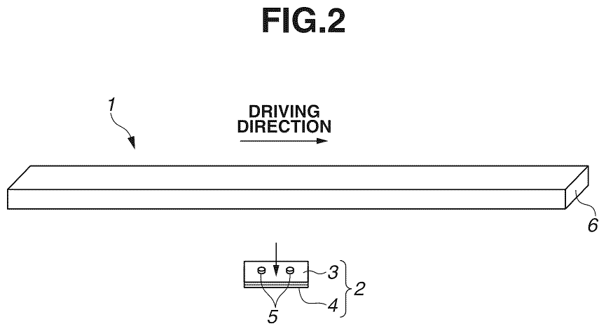

FIG. 2 is a diagram schematically illustrating the configuration of a vibration-type actuator 1. The vibration-type actuator 1 includes a vibration body 2, and a contact body 6 that comes into contact with the vibration body 2. The vibration body 2 includes an elastic body 3 and a piezoelectric element 4, which is an electromechanical energy conversion element bonded to a surface of the elastic body 3 in a second direction. The elastic body 3 includes a plate portion shaped like a flat plate, and two protruding portions 5 disposed in a first direction out of the plane of the plate portion. A vibration-type actuator can be manufactured by processing of preparing a vibrator including an electromechanical energy conversion element and an elastic body and processing of bringing the elastic body and a contact body into contact with each other.

The “contact body” refers to a member that comes into contact with the vibration body and moves relative to the vibration body due to a vibration generated in the vibration body. The contact between the contact body and the vibration body is not limited to direct contact without another member intervening between the contact body and the vibration body. The contact between the contact body and the vibration body may be indirect contact with another member intervening between the contact body and the vibration body as long as the contact body moves relative to the vibration body due to a vibration generated in the vibration body. The “other member” is not limited to a member independent of the contact body and the vibration body (for example, a highly frictional member including a sintered body). The “other member” may be a surface treated portion of the contact body or the vibration body that is formed by, for example, plating or a nitriding treatment.

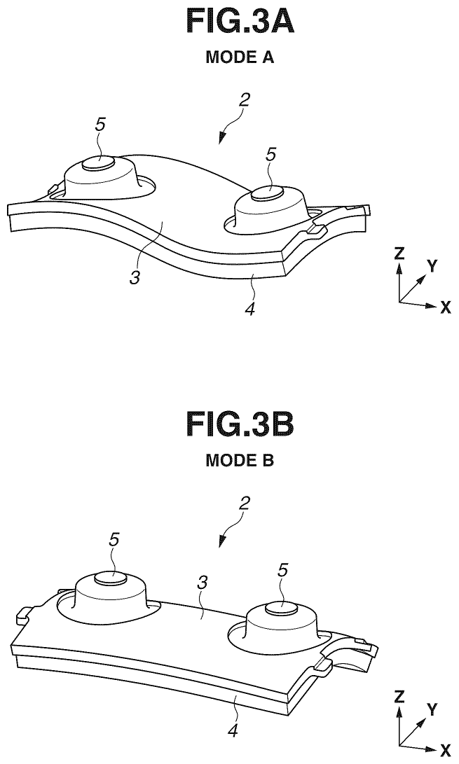

FIG. 3A is a diagram illustrating a first vibration mode (hereinafter referred to as a “mode A”) of two bending vibration modes excited in the vibration body 2. A common electrode (a full surface electrode) (not illustrated) is formed on a surface of the piezoelectric element 4 on which the elastic body 3 is provided. Driving electrodes (not illustrated), which are divided equally in the longitudinal direction, are formed on a surface of the piezoelectric element 4 opposite from the surface on which the elastic body 3 is provided.

The mode A is a second-order bending vibration in the longitudinal direction of the vibration body 2 (an X-direction), and has three nodal lines substantially parallel to the lateral direction of the vibration body 2 (a Y-direction). By applying an alternating voltage with a phase difference of 180° at a predetermined frequency to the driving electrodes of the piezoelectric element 4, the vibration in the mode A can be excited in the vibration body 2. The protruding portions 5 are each disposed in the vicinity of a position corresponding to a node of the vibration in the mode A, and perform reciprocating motion in the X-direction when the mode A vibration is excited in the vibration body 2.

FIG. 3B is a diagram illustrating a second vibration mode (hereinafter referred to as a “mode B”) of the two bending vibration modes excited in the vibration body 2. The mode B is a first-order bending vibration in the lateral direction of the vibration body 2 (the Y-direction), and has two nodal lines substantially parallel to the longitudinal direction (the X-direction). By applying alternating voltages in phase at a predetermined frequency to the driving electrodes of the piezoelectric element 4, the vibration in the mode B can be excited in the vibration body 2. The protruding portions 5 are each disposed in the vicinity of a position corresponding to an antinode of the vibration in the mode B, and performs reciprocating motion in the axial direction of the protruding portions 5 (a Z-direction) when t the mode B vibration is excited in the vibration body 2.

The vibration body 2 is configured in such a manner that the nodal lines in the mode A and the nodal lines in the mode B are substantially orthogonal to each other within an X-Y plane. A flexible printed circuit (not-illustrated) is bonded to the piezoelectric element 4, and the vibrations in the mode A and the mode B can be exited in the vibration body 2 simultaneously by supplying alternating-currents to the piezoelectric element 4 via the flexible printed circuit. Therefore, by exciting the vibrations in the mode A and the mode B with a predetermined phase difference generated therebetween, an elliptic motion can be generated at tips of the protruding portions 5 within a Z-X plane.

In the vibration-type actuator 1, the vibration body 2 and the contact body 6 are in contact with each other. Therefore, by exciting the vibrations in the mode A and the mode B in the vibration body 2 simultaneously with the contact body 6 supported to be drivable in the driving direction indicated by an arrow in FIG. 2 (the longitudinal direction of the contact body 6), the contact body 6 can be frictionally driven due to the protruding portions 5 to be thus driven in the driving direction.

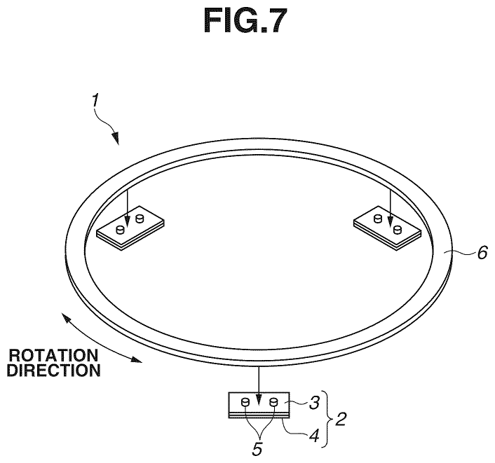

In FIG. 2, the illustration of a support member for supporting the contact body 6 to be drivable, a holding member for holding the vibration body 2, a pressing unit for bringing the vibration body 2 and the contact body 6 into contact with each other, and the like are omitted. While, in the present embodiment, the vibration-type actuator 1 is configured in such a manner that the vibration body 2 is fixed and the contact body 6 is drivable, it is also possible to adopt a configuration in which the contact body 6 is fixed and the vibration body 2 is driven together with the holding member. Alternatively, as illustrated in FIG. 7, the vibration-type actuator 1 may be configured in such a manner that a contact body 6 has a ring-like shape and a plurality of vibration bodies 2 is disposed and rotationally drive the contact body 6.

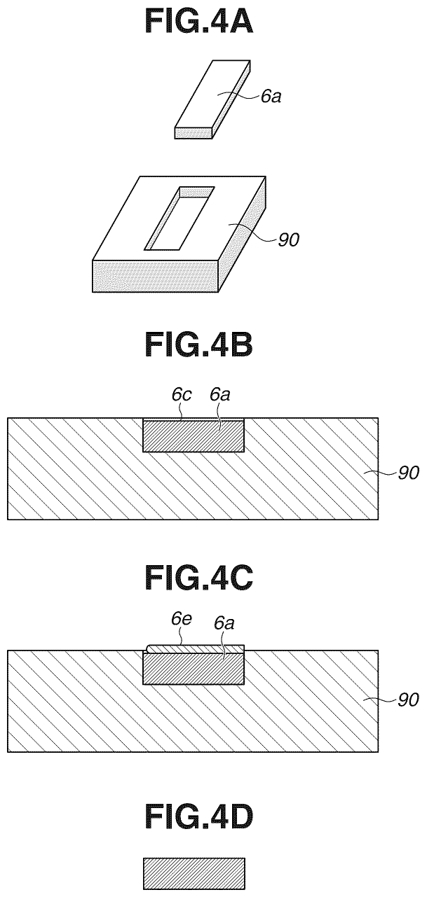

FIGS. 4A to 4D are disarms illustrating a method for manufacturing the contact body 6 illustrated in FIG. 2. The contact body 6 according to the present embodiment includes a sintered body 6a illustrated in FIG. 4A. It is desirable that the sintered body 6a be, for example, a sintered body containing martensite stainless steel corresponding to SUS420J2.

The sintered body 6a is manufactured by, for example, processing of molding raw-material powder that is a mixture of SUS410L powder and carbon powder, which have particle sizes of less than or equal to 150 micrometers (μm), and joining the powder particles by holding the acquired molded body under a predetermined temperature equal to or lower than the melting point (sintering processing). The sintered density of the sintered body 6a can be within a range from 6.1 grams per cubic centimeter (g/cc) to 6.6 g/cc.

It is desirable that the Vickers hardness of the sintered body 6a be 550 HV0.2 or higher, and, more desirably, 600 HV0.2 or higher to enhance the wear resistance of a frictional sliding contact surface. The hardness of the sintered body 6a is adjusted by sinter hardening of applying a heat treatment in the sintering processing by adjusting a cooling speed in a sintering furnace, quenching, or the like. The Vickers hardness of the sintered body 6a can be measured using a micro-Vickers. It is desirable that the hardness be measured using the micro-Vickers with a testing force of 200 grams (g) (=0.2 kilograms (kg)) on a metal surface polished after the sintered body 6a is impregnated with resin to reduce the influence imposed on the measurement value of the hardness by deformation in the vicinity of the surface of the sintered body 6a due to the presence of the pores in the sintered body 6a.

A two-liquid curable adhesive in a liquid form can be used as flowable resin applied to the sintered body 6a. A fluorescent dye may be added to the resin in advance to facilitate observation of the resin in a state of being contained in the pores. A main agent mainly containing epoxy resin in a liquid form, and a curing agent mainly containing an amine compound may be used as the resin (the adhesive). The viscosity after the mixture can be 8,000 millipascal-second (mPa·s) or higher and 30,000 mPa·s or lower. Because being expected to have a high friction coefficient after being cured, the resin is desirably 8,000 mPa·s in viscosity. To further enhance the holding force when the contact body 6 is used for the vibration-type actuator 1, it is desirable that hard particles be added to the resin. Desirably, the hard particles can be green carbide (GC) that is silicon carbide (SiC) abrasive grains having high purity and hardness.

A covering member 90, which covers surfaces of the sintered body 6a other than the surface thereof to which the resin is applied (hereinafter referred to as an application surface), is prepared as illustrated in FIG. 4A. It is desirable that the covering member 90 be made from rubber, and, more desirably, contain an adhesion-resistant material, such as Teflon (registered trademark), in at least a part of the surfaces of the covering member 90. Since the covering member 90 is made from rubber and is flexible, the sintered body 6a can be easily detached from the covering member 90. Since the covering member 90 contains the adhesion-resistant material in the surface thereof, the sintered body 6a can be easily detached from the covering member 90.

FIG. 4B illustrates a cross-sectional view in the longitudinal direction with the sintered body 6a illustrated in FIG. 4A set in the covering member 90. By fitting the sintered body 6a in the covering member 90 having a cavity conforming to the shape of the sintered body 6a in a covering process, the surfaces of the sintered body 6a other than a surface 6c to which the resin is to be applied are brought in contact with the covering member 90. With this configuration, the pores in the surfaces of the sintered body 6a other than the surface 6c is covered.

As illustrated in FIG. 4C, resin 6e which is epoxy resin in a liquid form is applied to the surface 6c (the application surface) of the sintered body 6a that serves as a frictional portion. The resin 6e may be applied using, for example, a dispenser apparatus (not illustrated). After the resin 6e is applied, confirmation is performed that the resin 6e has been applied to at least the entire surface of the surface 6c.

After that, in an impregnation process, a surface of the covering member 90 to which the epoxy resin 6e is not applied is brought into contact with a plate surface in a heated vacuum heating apparatus, and, further, a vacuum state is established. It is desirable that the temperature of the plate surface of the vacuum heating apparatus be, for example, approximately 80 Degrees Celsius (C). The viscosity of the epoxy resin 6e reduces due to heat transferred to the epoxy resin 6e via the covering member 90 and the sintered body 6a, and this facilitates a movement of the epoxy resin 6e inside the pores.

Here, the vacuum heating apparatus is an apparatus capable of performing heating and maintaining a pressure lower than the atmospheric pressure within a closed space. Desirably, the vacuum state is, for example, a state in which the air pressure is lowered to −0.085 megapascal (MPa).

The process according to the present embodiment can improve the impregnation efficiency for a reason that will be described now. According to such a principle that air moves from a low air pressure area to a high air pressure area, air used to be present in the pores of the sintered body 6a passes through the applied epoxy resin 6e in the vacuum state. After that, when the sintered body 6a is placed back under the atmospheric pressure, the applied resin is pushed into the pores of the sintered body 6a due to the atmospheric pressure, whereby the resin can be contained at a high content rate even at a further deep position in the sintered body 6a.

Further, if the surfaces other than the surface 6c with the resin applied thereto are in contact with the atmosphere, the air is also introduced from these surfaces when the sintered body 6a is placed back under the atmospheric pressure, and this undesirably impedes the permeation of the resin into the pores. Therefore, by covering the surfaces of the sintered body 6a other than the application surface with the covering member 90, the present embodiment can efficiently introduce the resin into the pores.

The present embodiment has been described using the example in which both the heating and vacuuming are conducted, but the heating may be omitted. Further, as the covering member 90, silicone tape may be used instead of the rubber container and the surfaces of the sintered body 6a other than the application surface may be covered with the silicone tape. Covering the pores of the sintered body 6a with the covering member 90 may be replaced with applying resin prepared in a highly viscous state and not containing a fluorescent dye to the surfaces of the sintered body 6a other than the surface to which the resin is applied in advance, and curing it.

The order of the processes included in the manufacturing process is not limited to the above-described order. For example, the manufacturing process may include a process of applying the resin to the application surface of the sintered body 6a after placing the sintered body 6a under an air pressure lower than the atmospheric pressure (under a second air pressure), and then holding the sintered body 6a under a pressure lower than the atmospheric pressure (under a first air pressure). In this processing, the first air pressure and the second air pressure may be equal to each other. Water molecules and the like attached inside the pores of the sintered body 6a and the gas in the pores can be removed by holding the sintered body 6a under the air pressure equal to the impregnation processing in advance. The first air pressure may be lower than the second air pressure. Performing the application processing under the second air pressure higher than the first pressure allows the resin to be applied at the same time as the vacuuming, which can shorten the manufacturing processing.

The inside of the vacuum heating apparatus is returned from the vacuum state to the normal pressure (1 atm) after the impregnation processing. This may be processing of returning the inside of the vacuum heating apparatus to an air pressure higher than the air pressure set when the impregnation processing is performed, instead of returning it to the normal pressure at once. Further, the sintered body 6a is left alone for a predetermined time under an environment of a predetermined temperature to cure the epoxy resin 6c. For example, the sintered body 6a can be left alone for approximately 30 minutes under an environment of approximately 80° C. to cure the resin quickly. The epoxy resin 6e in use is curable even under a room temperature, and therefore the sintered body 6a does not necessarily have to be left alone under a high temperature. After the resin is cured, the sintered body 6a is extracted out of the covering member 90.

In this series of resin impregnation processes, the resin is applied by a larger amount than the amount by which the resin actually permeates the inside of the pores, and consequently, the cured resin unintentionally remains on the surface corresponding to the contact surface. To remove this resin and correct the flatness of the contact surface and the back surface and the thickness of the contact body 6 to predetermined values, the sintered body 6a is ground after the resin is cured, and is further subjected to polishing processing to adjust, for example, the surface roughness of the surface. As a result, the contact body 6 is acquired as a finished product.

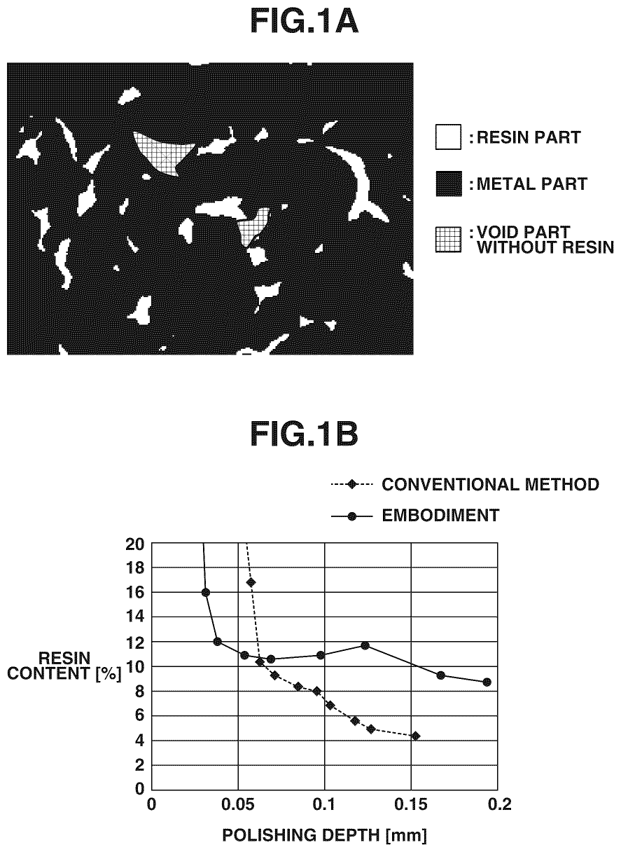

The configuration of the contact surface of the contact body 6 will be described with reference to the schematic view of FIG. 1A. FIG. 1A illustrates an image acquired by combining an image binarized in such a manner that the resin part is indicated in white and the rest is indicated in black after the contact surface has been imaged in a fluorescent observation mode of an optical microscope, and an image of the pores not containing the resin (illustrated in a gridded manner). The image of the pores can be acquired by imaging the same position in a reflected light observation mode of the optical microscope. The image can be captured using, for example, Axio Imager.A1m manufactured by Carl Zeiss, and can be acquired as an observation image at a magnification of 200 times with an imaging range of approximately 363 μm×272 μm. The proportion of the area occupied by the resin part in the contact surface of the contact body 6 (hereinafter referred to as a “resin content”) can be measured per polishing depth based on these observation images.

The resin content and the like may be calculated by another method, such as a method using an image acquired using a laser microscope and depth data. If no fluorescent dye is contained in the resin introduced in the pores, the content rate of the resin contained first can be calculated by further impregnating the pores of the surface with resin containing a fluorescent dye.

For the measurement of the resin content, it is desirable to measure the resin content at a plurality of portions in the surface of the contact body 6 that are spaced apart from each other, and calculate an average value of them. For an evaluation of the ring-shaped contact body, it is especially desirable to measure the resin content at intervals of 90° or intervals of 30° in the circumferential direction and calculate an average value thereof.

In this manner, the contact surface of the contact body 6 includes the metal part, the resin part in which the resin is contained in the pores, and the pores in which the resin is not contained. In other words, a sum of the proportions occupied by the “metal part”, the “resin part”, and the “void part not containing the resin” in the contact surface of the contact body 6 is 100%. Further, a sum of the proportions of the “void part” and the “metal part” of the sintered body 6a is 100%, and a sum of the proportions of the “resin part” and the “void part not containing the resin” is equal to the proportion of the “void part” of the sintered body 6a. In the case where the SUS410L powder having a particle diameter of 150 μm or smaller is used as the raw-material of the sintered body 6a, the pores of the sintered body 6a has the maximum length of several μm to approximately 100 μm.

When A₀(%) represents the proportion of the area occupied by the resin part in the contact surface, and A₅₀(%) represents the proportion of the area occupied by the above-described resin part in the surface when the contact surface is polished by 50 μm in a depth direction perpendicular to the contact surface, desirably, A₀ is 8% or higher, and the following general formula (1) is satisfied.

$$( {A}_{0} - {A}_{50} ) / {A}_{0} \leq 0.25 \qquad ( 1 )$$

In this manner, a further increase in the proportion of the resin part (the resin content) in the surface of the contact body 6 allows the vibration-type actuator 1 to exhibit a high holding force. The resin content reduces at a low rate in the range of the predetermined polishing depth of the contact body 6, and this allows the vibration-type actuator 1 to exhibit a high holding force even when the surface of the contact body 6 is worn. Further, the contained amount of the resin is less likely to decrease even at a position deeper than the surface of the sintered body 6a, and this allows the resin to be easily contained by a predetermined or larger amount in the surface of the acquired contact body 6 even when there is a variation in the amount by which the surface of the sintered body 6a is polished in the manufacturing processing.

### First Example

In the following description, an example of manufacturing the contact body 6 according to the first embodiment will be specifically described. The sintered body 6a was impregnated with the resin by applying the epoxy resin 6e to the application surface and letting the sintered body 6a stand under the vacuum environment together with the covering member 90, after covering the surfaces other than the application surface with the highly viscous resin and curing it instead of fitting the sintered body 6a in the covering member 90. In the present example, the ring-shaped contact body illustrated in FIG. 7 was manufactured.

In the present example, martensitic stainless steel corresponding to SUS420J2 stipulated in the Japanese Industrial Standards (JIS) was used as the sintered body 6a. The sintered body 6a was manufactured by the processing of molding raw-material powder as a mixture of SUS410L powder and carbon powder having particle sizes of 150 μm or smaller, and joining the powder particles by holding the acquired molded body under a predetermined temperature equal to or lower than the melting point of stainless steel (the sintering process).

The two-liquid curable adhesive was used as the resin to impregnate the pores of the sintered body 6a. Further, the fluorescent dye was mixed in the resin (the adhesive) in advance to observe the resin in a state of being contained in the pores. In the present example, the main agent mainly containing epoxy resin in a liquid form, and the curing agent mainly containing an amine compound were used as the resin (the adhesive). The viscosity after the two kinds of resin liquid was mixed were 8,000 mPa·s or higher and 30,000 mPa·s or lower. To further improve the holding force when the contact body would be used for the vibration-type actuator 1, GC as SiC abrasive grains having very high purity and hardness, which were hard particles, was spread in the resin.

Subsequently, the surfaces other than the application surface were covered by applying the resin prepared in a highly viscous state and not containing a fluorescent dye to the surfaces of the sintered body 6a other than the surface where the resin would be applied, and curing it in advance. In the application processing, the resin with the two kinds of liquid mixed therein was applied to the whole surface of the application surface (the surface 6c) of the sintered body 6a using the dispenser apparatus.

Further, in the impregnation processing, the surface of the covering member 90 to which the epoxy resin 6e was not applied was brought into contact with the plate surface in the vacuum heating apparatus heated to approximately 80° C., and, further, a vacuum state was established. In the present example, the air pressure was lowered to −0.085 MPa as the process for establishing the vacuum state.

After the inside of the vacuum heating apparatus was returned to the normal pressure (1 atm), the sintered body 6a was left alone for 30 minutes under an environment of approximately 80° C. After the resin was confirmed to be cured, the sintered body 6a was extracted out of the covering member 90. The acquired composite of the sintered body 6a and the resin was polished by using a copper surface plate and free abrasive grains of diamond (3 μm) to process the contact surface into a smooth surface so that the contact body was acquired.

Subsequently, the manufactured contact body was evaluated. The fluorescent observation and the reflected light observation were conducted on the surface of the contact body by using the optical microscope, and the resin content in the surface of the contact body was calculated. For both the observations, the surface of the contact body was imaged using Axio Imager.A1m manufactured by Carl Zeiss at a magnification of 200 times, and the imaging range was approximately 363 μm×272 μm.

FIG. 1B illustrates the result of measuring the resin content per polishing depth. The contact body was fabricated by performing the processing of applying the resin prepared in a highly viscous state and not containing a fluorescent dye to the surfaces of the sintered body 6a other than the application surface in advance, and curing it, instead of covering the pores of the sintered body 6a with the covering member 90 of the present example.

FIG. 1B indicates the result of the conventional manufacturing method described in Japanese Patent Laid-Open No. 2022-30103 with a dotted line and the result of the present example with a solid line.

The density of a sintered body sintered in the same lot as the measured sintered body 6a was 6.3 g/cc as a result of measuring it according to the Archimedes method. The density of a molten material of SUS420J2 was 7.75 g/cc, and therefore the proportion of the pores of the sintered body 6a was approximately 19%.

The proportion of the pores in the polished surface for each polishing depth was measured using the image captured at 200 times in the reflected light observation mode of Axio Imager.A1m manufactured by Carl Zeiss. The measurement range was approximately 363 μm×272 μm. Polishing scratches having a depth of several microns or less that were caused by the polishing abrasive grains used at the time of the polishing were not counted as the pores.

On the other hand, the resin content was measured using an image acquired by imaging the same field of view in the fluorescent observation mode of Axio Imager.A1m manufactured by Carl Zeiss. Because only the resin part emitted light when being observed using the fluorescent microscope since the fluorescent dye was contained in the resin, the proportion of the resin impregnated portion was able to be measured.

As illustrated in FIG. 1B, the resin content reduced as being located farther away from the application surface. Especially, the resin content changed at a high rate until reaching the polishing depth of approximately 0.05 mm. It may be attributable to the fact that the sintered body 6a had less neck portions where the sintered powder particles were joined to each other at a depth of approximately 0 to 0.05 mm, which was the outermost layer of the sintered body 6a.

In the present example, the resin content reduced at a lower rate than that of the conventional manufacturing method at a polishing depth of approximately 0.05 mm or deeper. The resin content in the polished surface was higher than the conventional manufacturing method at the same polishing depth.

### Second Embodiment

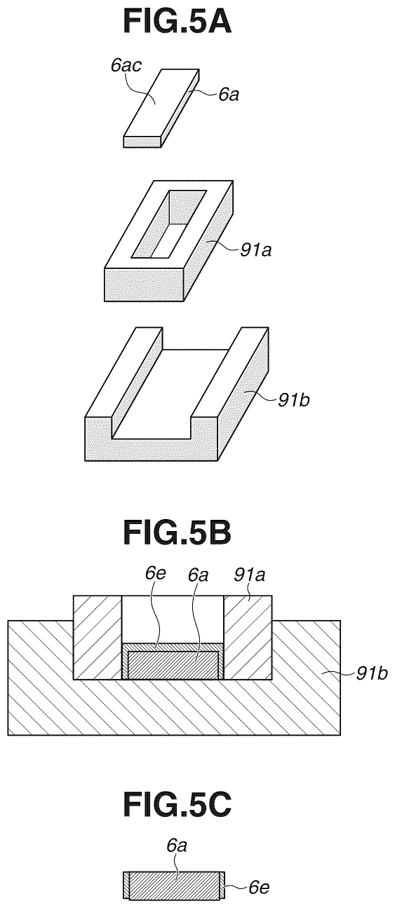

A second embodiment of the present disclosure will be described with reference to FIGS. 5A to 5C. FIGS. 5A to 5C illustrate a method for manufacturing the contact body 6 illustrated in FIG. 2. The sintered body 6a is manufactured by the similar method as the first embodiment. The resin contained in the pores may also be the same as the first embodiment, and therefore the redundant description will be omitted here.

As illustrated in FIG. 5A, adhesion-resistant tools 91a and 91b are prepared. The adhesion-resistant tools 91a and 91b are used to prevent contact between the pores of the sintered body 6a and the atmosphere at the time of resin impregnation. An adhesion-resistant tool 91, which is acquired by combining the adhesion-resistant tools 91a and 91b, has a cavity larger than the sintered body 6a. The material of the adhesion-resistant tools 91a and 91b is desirably an adhesion-resistant plastic or rubber material, such as ethylene propylene diene monomer (EPDM) rubber, polypropylene resin, or Teflon resin. A release agent may be applied to the adhesion-resistant tools 91a and 91b.

FIG. 5B illustrates a cross-sectional view in the longitudinal direction with the sintered body 6a illustrated in FIG. 5A set in the adhesion-resistant tools 91a and 91b and the resin applied thereto. The epoxy resin 6e is not only applied to the application surface by using a dispenser apparatus (not-illustrated), but also applied in such a manner that surfaces other than the surface on which the sintered body 6a is in contact with the adhesion-resistant tool 91, i.e., a space between the adhesion-resistant tool 91a and the sintered body 6a is also filled with the epoxy resin 6e. The space between the adhesion-resistant tool 91a and the sintered body 6a is desirably 5 μm or larger from the perspective of protecting the surface of the contact body 6. This process can establish a state in which the pores of the sintered body 6a are out of contact with the atmosphere.

After that, a surface of the adhesion-resistant tool 91 to which the epoxy resin 6e is not applied is brought into contact with a plate surface in a heated vacuum heating apparatus, and, further, a vacuum state is established. It is desirable that the temperature of the plate surface of the vacuum heating apparatus be, for example, approximately 80° C. When the sintered body 6a is placed back under the atmospheric pressure after that, the applied resin is pushed into the pores of the sintered body 6a due to the atmospheric pressure, and this can promote the impregnation.

If the surfaces other than the surface 6c with the resin applied thereto are in contact with the atmosphere when the sintered body 6a is placed back under the atmospheric pressure, the air is also introduced from these surfaces when the sintered body 6a is placed back under the atmospheric pressure, and this may impede the impregnation with the resin. In the present embodiment, the surfaces other than the surface 6c with the resin applied thereto are also in close contact with the resin or the adhesion-resistant tool 91a, and therefore the sintered body 6a can be effectively impregnated when being placed back under the atmospheric pressure. Both the heating and vacuuming are conducted in the present embodiment, but the heating may be omitted.

After that, the sintered body 6a is left alone for approximately 30 minutes under approximately 80° C. to cure the epoxy resin 6e. The epoxy resin 6e in use is curable even under a room temperature, and therefore the sintered body 6a does not necessarily have to be left alone under a high temperature. After the resin is cured, the sintered body 6a is released from the adhesion-resistant tools 91a and 91b. Since the adhesion-resistant tools 91a and 91b are made from the adhesion-resistant material, the resin applied to coat the sintered body 6a around it can be easily released from the adhesion-resistant tools 91a and 91b.

In this series of resin impregnation processing, the resin is applied by a larger amount than the amount by which the sintered body 6a is impregnated with (permeated by) the resin actually, and therefore the cured resin unintentionally remains on the surface of the sliding portion. To remove this resin and correct the flatness of the contact portion and the back surface and the thickness of the contact body 6 to predetermined values, the sintered body 6a is ground after the resin is cured, and is further subjected to polishing processing to adjust, for example, the surface roughness of the surface. Then, the contact body 6 is acquired as a finished product. As a result, the surfaces of the contact body 6 different from the contact surface are coated with the resin having a film thickness of 5 μm or greater, and the contact body 6 can also be expected to be improved in corrosion resistance.

### Third Embodiment

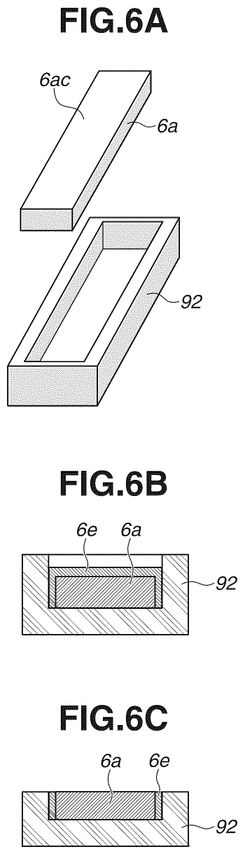

A third embodiment of the present disclosure will be described with reference to FIGS. 6A to 6C. FIGS. 6A to 6C are diagrams illustrating a method for manufacturing the contact body 6 illustrated in FIG. 2. The sintered body 6a is manufactured by the similar method as the first embodiment. The resin in use may also be the same as the first embodiment, and therefore the redundant description will be omitted here.

As illustrated in FIG. 6A, a highly processable container 92 is prepared. The highly processable container 92 is used to prevent contact between the pores of the sintered body 6a and the atmosphere at the time of resin impregnation. The material of the highly processable container 92 can be a highly processable and general-purpose material, and, more desirably, can be acrylonitrile-ethylene-styrene (AES) resin. The dimension of the highly processable container 92 and the dimension of the sintered body 6a are designed in consideration of a desired dimension of the contact body 6.

FIG. 6B illustrates a cross-sectional view in the longitudinal direction with the sintered body 6a illustrated in FIG. 6A set in the highly processable container 92 and the resin applied thereto. The epoxy resin 6e in a liquid form is not only applied to a surface 6ac of the sintered body 6a that serves as the frictional portion, by using a dispenser apparatus (not-illustrated), but also applied in such a manner that the outer surfaces of the sintered body 6a, i.e., a space between the highly processable container 92 and the sintered body 6a is also filled with the epoxy resin 6e. This can establish a state in which the pores of the sintered body 6a are out of contact with the atmosphere.

After that, a surface of the highly processable container 92 to which the epoxy resin 6e is not applied is brought into contact with a plate surface in a heated vacuum heating apparatus, and, further, a vacuum state is established. It is desirable that the temperature of the plate surface of the vacuum heating apparatus be, for example, approximately 80° C. When the sintered body 6a is placed back under the atmospheric pressure after that, the applied resin is pushed into the pores of the sintered body 6a due to the atmospheric pressure, and this can promote the impregnation.

If the surfaces other than the surface 6c with the resin applied thereto are in contact with the atmosphere when the sintered body 6a is placed back under the atmospheric pressure, the air is also introduced from these surfaces when the sintered body 6a is placed back under the atmospheric pressure, and this undesirably impedes the impregnation with the resin. In the present embodiment, the surfaces other than the surface 6ac with the resin applied thereto are also covered with the resin or the highly processable container 92, and therefore the sintered body 6a can be effectively impregnated when being placed back under the atmospheric pressure. Both the heating and vacuuming are conducted in the present embodiment, but the heating may be omitted.

After that, the sintered body 6a is left alone for approximately 30 minutes under approximately 80° C. to cure the epoxy resin 6e. The epoxy resin 6e in use is curable even under a room temperature, and therefore the sintered body 6a does not necessarily have to be left alone under a high temperature. In this series of resin impregnation processing, the resin is applied by a larger amount than the amount by which the sintered body 6a is impregnated with (permeated by) the resin actually, and therefore the cured resin unintentionally remains on the surface of the sliding portion. For the purpose of removing this resin and correcting the flatness of the contact surface and the back surface and the thickness of the contact body 6 to predetermined values, the sintered body 6a is ground after the resin is cured, and is further subjected to polishing processing to adjust, for example, the surface roughness of the surface. Then, the contact body 6 illustrated in FIG. 6C is acquired as a finished product. The side surface may be subjected to cutting or the like. At this time, the sintered body 6a may be cut and polished together with the highly processable container 92 without performing the processing of removing the sintered body 6a from the highly processable container 92. In other words, the contact body 6 may be acquired by polishing the surface of the composite of the highly processable container 92, the sintered body 6a, and the resin. The surface of the contact body 6 can be protected by the highly processable container 92 by processing the sintered body 6a together with the highly processable container 92 to acquire the contact body 6.

### <Application Example of Vibration-Type Actuator>

An imaging apparatus and an industrial robot will be described as examples of an optical apparatus and an electronic apparatus to which the vibration-type actuator 1 using the above-described contact body 6 is applied.

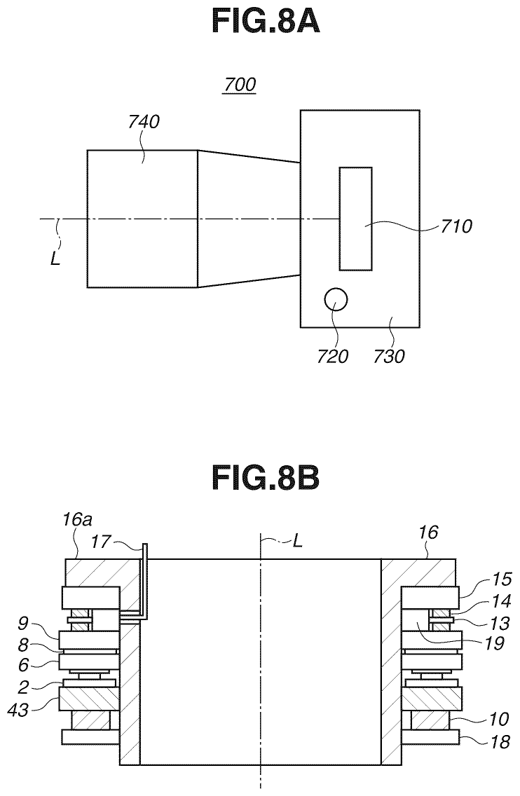

FIG. 8A is a top view schematically illustrating the configuration of an imaging apparatus 700 (an apparatus), which is an example of the optical apparatus. The imaging apparatus 700 includes a camera main body 730 equipped with an image sensor 710 and a power button 720. The imaging apparatus 700 includes a lens barrel 740 equipped with a lens group and a vibration-type actuator, neither of which is illustrated. The lens group is driven by the vibration-type actuator. The lens barrel 740 is replaceable as an interchangeable lens, and the lens barrel 740 appropriate to an imaging target can be attached to the camera main body 730. The vibration-type actuator described with reference to FIG. 2 can be used as the vibration-type actuator.

It is considered that the driving of the lens by the vibration-type actuator may be suitable for driving an auto-focus lens, but is not limited thereto, and a zoom lens can also be driven by a similar configuration. The vibration-type actuator can also be used to drive the image sensor, or drive the lens or the image sensor at the time of a correction for a camera shake.

FIG. 8B is a cross-sectional view schematically illustrating an example of the configuration in which the vibration-type actuator 1 is implemented in the lens barrel 740, and indicated in a cross section including an optical axis L. The contact body 6 is disposed in such a manner that the contact surface is in contact with the protruding portions 5 (not labeled in FIG. 8B) of the vibration body 2. An output transmission member 9 is installed on the surface of the contact body 6 opposite from the contact surface with a rotor rubber (an anti-vibration rubber) 8 interposed therebetween.

On the other hand, a leaf spring 10 is provided on the opposite side of a holding base 43, which holds the vibration body 2 so as not to interfere with the vibration, from the contact body 6. The leaf spring 10 serves as a pressing unit for pressing the vibration body 2 against the contact body 6 with a predetermined force. To compress the leaf spring 10 to generate the pressing force, a pressing ring 18 for regulating a deflection amount of the leaf spring 10 is provided and the leaf spring 10 is held between the pressing ring 18 and the holding base 43. With this configuration, an appropriate pressing force is applied between the vibration body 2 and the contact body 6.

A flange 16a, which protrudes perpendicularly to an optical axis direction (a direction in which the optical axis L extends), is provided on a barrel unit main body 16, and a manual ring 15, which is used to perform manual focusing, is manually rotatably disposed on one surface of the flange 16a. A roller ring 19, which is rotatable by a rotational operation of the manual ring 15 or output transmission from the vibration-type actuator 1, is installed between the manual ring 15 and the vibration-type actuator 1. The lens barrel 740 is configured in such a manner that, when the roller ring 19 is rotated, a cam ring and the like are rotated via an output key 17 provided on the roller ring 19.

Roller shafts 13 are provided on the roller ring 19 at a plurality of positions so as to radially extend, and rollers 14 are mounted on the roller shafts 13 rotatably about the roller shafts 13. The lens barrel 740 is configured in such a manner that the output transmission member 9 and the manual ring 15 are stacked in the optical axis direction with the rollers 14 held therebetween. The inner peripheral side of the pressing ring 18 is engaged with the barrel unit main body 16 by a screw or a bayonet structure. The compression amount of the leaf spring 10 can be adjusted by rotating the pressing ring 18 to move it in the optical axis direction. With this configuration, each of the components from the holding base 43 to the flange 16a via the manual ring 15 is pressed and supported.

When the vibration-type actuator 1 is driven, the contact body 6 is rotated about the optical axis L, and this causes the contact body 6, the rotor rubber 8, and the output transmission member 9 to be integrally rotated about the optical axis L. Then, the rollers 14, which are in contact with the output transmission member 9, are rotated about the optical axis L together with the roller ring 19 while rolling on the surface of the manual ring 15, and the cam ring and the like (not-illustrated) are rotated by the output key 17 disposed on the roller ring 19, as a result of which an auto-focus operation or the like is performed.

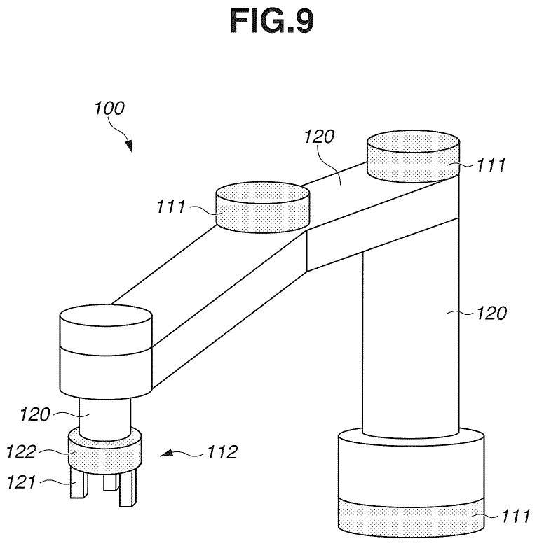

FIG. 9 is a perspective view schematically illustrating the configuration of a robot 100 (the apparatus) with the vibration-type actuator 1 mounted thereon, which is an example of the electronic apparatus, and illustrates a horizontal articulated robot, which is one type of industrial robot, in the present example.

The robot 100 includes arm joint portions 111 and a hand portion 112. The arm joint portions 111 connect two arms 120 in such a manner that the two arms 120 can intersect with each other at a changeable angle. The hand portion 112 includes the arm 120, a grip portion 121 attached to one end of the arm 120, and a hand joint portion 122 connecting the arm 120 and the grip portion 121. The vibration-type actuator 1 is built in the arm joint portions 111 and/or the grip portion 121, and adjusts the angle of the arm 120 or the hand joint portion 122 and performs a rotational operation.

A vibration-type actuator having a torque-speed (TN) characteristic (a drooping characteristic indicating a relationship between a load torque and a rotational speed) of a low rotational speed and a high torque can be used for bending of the arm joint portions 111 and a griping operation of the hand portion 112.

Having described the present disclosure in detail based on exemplary embodiments thereof, the present disclosure is not limited to these specific embodiments, and also covers various embodiments within a range that does not depart from the spirit of the present disclosure. For example, an XY stage can be cited as an apparatus capable of driving a flat-shaped contact body in any in-plane direction thereof.

The disclosure of the present embodiment includes the following Methods and Configurations.

### (Method 1)

A method for manufacturing a contact body that is used for a vibration-type actuator, the method comprising:
applying resin having viscosity of 8,000 millipascal-second (mPa·s) or higher to a part of surfaces of a sintered body having pores;
covering pores in a surface of the sintered body that is different from the part of the surfaces; and
impregnating the sintered body with the resin applied to the sintered body by placing the sintered body under a first air pressure lower than an atmospheric pressure.

### (Method 2)

The method for manufacturing the contact body according to Method 1, wherein the impregnating is performed after the applying and the covering.

### (Method 3)

The method for manufacturing the contact body according to Method 1, wherein the impregnating is performed after the applying has been performed under a second air pressure lower than the atmospheric pressure.

### (Method 4)

The method for manufacturing the contact body according to Method 3, wherein the first air pressure and the second air pressure are equal to each other.

### (Method 5)

The method for manufacturing the contact body according to Method 3, wherein the first air pressure is lower than the second air pressure.

### (Method 6)

The method for manufacturing the contact body according to Method 1,
wherein the covering includes fitting the sintered body to a covering member and bringing a surface of the covering member into contact with the surface of the sintered body that is different form the part of the surfaces, and
wherein the covering member has a cavity conforming to a shape of the sintered body.

### (Method 7)

The method for manufacturing the contact body according to Method 6, further comprising removing the sintered body from the covering member after the impregnating.

### (Method 8)

The method for manufacturing the contact body according to Method 1,
wherein the covering includes setting the sintered body into an adhesion-resistant tool having a cavity larger than the sintered body, and
wherein the applying includes covering a surface of the sintered body that is different from a surface on which the sintered body is in contact with the adhesion-resistant tool, with the resin.

### (Method 9)

The method for manufacturing the contact body according to Method 8, further comprising:
releasing the sintered body with at least the part of the surfaces covered with the resin from the adhesion-resistant tool,
wherein the adhesion-resistant tool contains an adhesion-resistant material in at least a part of the surfaces.

### (Method 10)

The method for manufacturing the contact body according to Method 1,
wherein the covering includes setting the sintered body in a highly processable container, and
wherein the applying includes covering an outer surface of the sintered body with the resin.

### (Method 11)

The method for manufacturing the contact body according to Method 10, further comprising polishing a surface of a composite of the highly processable container, the sintered body, and the resin after the impregnating, to acquire the contact body.

### (Method 12)

A method for manufacturing a vibration-type actuator, the method comprising:
acquiring the vibration-type actuator through:
acquiring the contact body by performing the method according to any one of Methods 1 to 11;
preparing a vibrator including an electromechanical energy conversion element and an elastic body; and
bringing the elastic body and the contact body into contact with each other.

### (Configuration 1)

A vibration-type actuator comprising:
a vibrator including an electromechanical energy conversion element and an elastic body; and
a contact body configured to be in contact with a surface of the elastic body on a contact surface of the contact body,
wherein the vibrator and the contact body move relative to each other due to a vibration of the vibrator,
wherein the contact body includes a sintered body having pores, and a resin part containing resin in the pores, and
wherein the following inequality is satisfied:

(A₀−A₅₀)/A₀≤0.25
where A₀ is a proportion of an area occupied by the resin part in the contact surface and A₅₀ is a proportion of an area occupied by the resin part in a surface when the contact surface is polished by 50 micrometers (μm) in a depth direction perpendicular to the contact surface, and A₀ is 8% or higher.

### (Configuration 2)

The vibration-type actuator according to Configuration 1, wherein the resin includes epoxy resin.

### (Configuration 3)

The vibration-type actuator according to Configuration 1, wherein a surface of the contact body that is different from the contact surface is coated with resin having a film thickness of 5 μm or greater.

### (Configuration 4)

The vibration-type actuator according to Configuration 1, wherein the sintered body is a stainless-steel sintered body having a primary particle diameter of 150 μm or smaller and a sintered density within a range from 6.1 grams per cubic centimeter (g/cc) to 6.6 g/cc, and
wherein a hard particle is added to the resin.

### (Configuration 5)

An optical apparatus comprising:
the vibration-type actuator according to any one of Configurations 1 to 4; and
at least one of an optical element or an image sensor configured to be driven by the vibration-type actuator.

### (Configuration 6)

An electronic apparatus comprising:
a member; and
the vibration-type actuator according to any one of Configurations 1 to 5, the vibration-type actuator being configured to drive the member.

The present disclosure is not limited to the above-described embodiments, and various modifications and alterations can be made without departing from the spirit and scope of the disclosure. Accordingly, the following claims are appended in order to publicly disclose the scope of the disclosure.

According to the present disclosure, it is possible to provide a method for manufacturing a contact body that is used for a vibration-type actuator, and a method for manufacturing a contact body containing a greater amount of resin in pores in a contact surface and also containing a greater amount of resin even at a position deeper than the contact surface.

Further, according to the present disclosure, it is possible to provide a vibration-type actuator including a contact body containing a greater amount of resin in pores in a contact surface and also containing a greater amount of resin even at a position deeper than the contact surface.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A method for manufacturing a contact body that is used for a vibration-type actuator, the method comprising:
applying resin, having viscosity of 8,000 millipascal-second (mPa·s) or higher, to a part of surfaces of a sintered body having pores;
covering pores in a surface of the sintered body that is different from the part of the surfaces; and
impregnating the sintered body with the resin applied to the sintered body by placing the sintered body under a first air pressure lower than an atmospheric pressure.

2. The method for manufacturing the contact body according to claim 1, wherein the impregnating is performed after the applying and the covering.

3. The method for manufacturing the contact body according to claim 1, wherein the impregnating is performed after the applying has been performed under a second air pressure lower than the atmospheric pressure.

4. The method for manufacturing the contact body according to claim 3, wherein the first air pressure and the second air pressure are equal to each other.

5. The method for manufacturing the contact body according to claim 3, wherein the first air pressure is lower than the second air pressure.

6. The method for manufacturing the contact body according to claim 1,
wherein the covering includes fitting the sintered body to a covering member and bringing a surface of the covering member into contact with the surface of the sintered body that is different form the part of the surfaces, and
wherein the covering member has a cavity conforming to a shape of the sintered body.

7. The method for manufacturing the contact body according to claim 6, further comprising removing the sintered body from the covering member after the impregnating.

8. The method for manufacturing the contact body according to claim 1,
wherein the covering includes setting the sintered body into an adhesion-resistant tool having a cavity larger than the sintered body, and
wherein the applying includes covering a surface of the sintered body that is different from a surface on which the sintered body is in contact with the adhesion-resistant tool, with the resin.

9. The method for manufacturing the contact body according to claim 8, further comprising:
releasing the sintered body with at least the part of the surfaces covered with the resin from the adhesion-resistant tool,
wherein the adhesion-resistant tool contains an adhesion-resistant material in at least a part of the surfaces.

10. The method for manufacturing the contact body according to claim 1,
wherein the covering includes setting the sintered body in a highly processable container, and
wherein the applying includes covering an outer surface of the sintered body with the resin.

11. The method for manufacturing the contact body according to claim 10, further comprising polishing a surface of a composite of the highly processable container, the sintered body, and the resin after the impregnating, to acquire the contact body.

12. A method for manufacturing a vibration-type actuator, the method comprising:
acquiring the vibration-type actuator through:
acquiring the contact body by performing the method according to claim 1;
preparing a vibrator including an electromechanical energy conversion element and an elastic body; and
bringing the elastic body and the contact body into contact with each other.

13. A vibration-type actuator comprising:
a vibrator including an electromechanical energy conversion element and an elastic body; and
a contact body configured to be in contact with a surface of the elastic body on a contact surface of the contact body,
wherein the vibrator and the contact body move relative to each other due to a vibration of the vibrator,
wherein the contact body includes a sintered body having pores, and a resin part containing resin in the pores, and
wherein the following inequality is satisfied:
$$( {A}_{0} - {A}_{50} ) / {A}_{0} \leq 0.25$$
where A₀ is a proportion of an area occupied by the resin part in the contact surface, A₅₀ is a proportion of an area occupied by the resin part in a surface when the contact surface is polished by 50 micrometers (μm) in a depth direction perpendicular to the contact surface, and A₀ is 8% or higher.

14. The vibration-type actuator according to claim 13, wherein the resin includes epoxy resin.

15. The vibration-type actuator according to claim 13, wherein a surface of the contact body that is different from the contact surface is coated with resin having a film thickness of 5 μm or greater.

16. The vibration-type actuator according to claim 13, wherein the sintered body is a stainless-steel sintered body having a primary particle diameter of 150 μm or smaller and a sintered density within a range from 6.1 grams per cubic centimeter (g/cc) to 6.6 g/cc, and
wherein a hard particle is added to the resin.

17. An optical apparatus comprising:
the vibration-type actuator according to claim 13; and
at least one of an optical element or an image sensor configured to be driven by the vibration-type actuator.

18. An electronic apparatus comprising:
a member; and
the vibration-type actuator according to claim 13, the vibration-type actuator being configured to drive the member.
